(19) United States
(12) Patent Application Publication
(10) Pub. No.: US 2024/0199162 A1
(43) Pub. Date: Jun. 20, 2024

(54) BICYCLE FRONT FORK CROWN STRUCTURE

(71) Applicant: Ming-Ta Tsai, NEW TAIPEI CITY (TW)

(72) Inventor: Ming-Ta Tsai, NEW TAIPEI CITY (TW)

(21) Appl. No.: 18/081,691

(22) Filed: Dec. 15, 2022

(51) Int. Cl. B62K 21/04; B62J 6/03; B62K 21/02

(52) U.S. Cl. CPC B62K 21/04; B62J 6/03; B62K 21/02

(57) ABSTRACT

A bicycle front fork crown structure is provided. The bicycle front fork crown structure can be mounted on a bifurcation of the top tube of the bicycle front fork and the bicycle front fork. The bicycle front fork crown structure includes an annular base. The annular base includes a front cover, a rear cover, and an engaging groove between the front cover and the rear cover; wherein the front cover has a fixing hole.

### FIELD OF THE DISCLOSURE

The present disclosure relates to the bicycle field, and more particularly to a bicycle front fork crown structure mounted on a bicycle front fork.

### BACKGROUND OF THE DISCLOSURE

With the evolution of the times and the change in domestic traffic conditions, the means of transportation used by modern people are no longer limited to cars, motorcycles, etc. The use of public transportation or human-powered vehicles as transportation is also quite popular.

At the same time, with the progress of the times, modern people are quite satisfied with basic food, clothing, housing, and transportation, and start to look for self-realization, and the sports trend also rises. Many people have begun to take great interest in cycling, which not only can be used as a transportation way, but also as an exercise. Therefore, the bicycle industry is growing with time.

The bicycle front fork crown is an accessory mounted on the bicycle front fork, which can be connected and mounted with other bicycle accessories. Different bicycle front fork crowns are mounted on different positions of the bicycle front fork. In the past, the crown on the front fork of the bicycle usually had a multi-component complex installation structure and was difficult to mount stably, which also resulted in problems of stability and poor use effect in operation. Therefore, if the above problems can be optimized and improved, the applicability of the bicycle front fork crown can be increased.

In addition, the size and shape of the shock absorber would affect the coordination of the overall appearance. Therefore, for users who care about the appearance of bicycles, so it is also important to have auxiliary accessories that can be decorated and provide appearance modification on the front fork.

### SUMMARY OF THE DISCLOSURE

The main purpose of the present disclosure is to provide a bicycle front fork crown structure that can be easily and stably mounted on the bifurcation of the bicycle front fork top tube and the bicycle front fork. Further, another purpose is to adjust the coordination of the overall appearance of the bicycle front fork according to the types of bicycles (such as road bikes, mountain bikes, and beach bikes). Compared with the conventional art, the structure of the present disclosure has better stability, and is easy to assemble.

In order to achieve the above-mentioned objective and effort, the present disclosure provides a bicycle front fork crown structure, including an annular base with a front cover, a rear cover, and an engaging groove between the front cover and the rear cover; wherein the front cover has a fixing hole.

In certain embodiments, the front cover has an extension portion extended outward from the front cover and including a first assembly rib and a second assembly rib spaced apart.

In certain embodiments, the annular base of the present disclosure includes a fixing fastener threadedly engaged to the fixing hole.

In certain embodiments, the inner side of the annular base of the present disclosure includes an inner convex ring extended inward.

In certain embodiments, the inner convex ring of the present disclosure has an inner convex ring surface, which mainly adorns the coordination of the appearance of the front forks of various bicycles and the balance with the overall aesthetic feeling.

In operation, the user only needs to detach the handlebar of the bicycle from the front fork of the bicycle, and then place the front cover of the structure in the direction of the front of the bicycle, and sleeve from the top of the top tube of the front fork of the bicycle, so that the structure of the present disclosure is sleeved around the top tube of the front fork of the bicycle movably. The bifurcation of the front fork of the bicycle blocks the structure and a fixing fastener threadedly engages with the fixing hole, so as to fix the structure at the front fork of the bicycle.

### BRIEF DESCRIPTION OF THE DRAWINGS

The described embodiments may be better understood by reference to the following description and the accompanying drawings in which:

FIG. 1 is a perspective schematic view of the first embodiment of the present disclosure.

FIG. 2 is a perspective schematic view of the second embodiment of the present disclosure.

FIG. 3 is a schematic perspective view of another angle of the second embodiment of the present disclosure.

FIG. 4 is a schematic perspective view of another angle of the second embodiment of the present disclosure.

FIG. 5 is a perspective schematic view of the bicycle front fork crown structure mounted on a bicycle front fork.

FIG. 6 is an exploded schematic view of the bicycle front fork crown structure mounted on a bicycle front fork.

FIG. 7 is a sectional schematic view of line VII-VII of FIG. 5 of the present disclosure.

FIG. 8 is a sectional schematic view if line VIII-VIII of FIG. 5 of the present disclosure.

FIG. 9 is a schematic view of the bicycle front fork crown structure of the second embodiment of the present disclosure in practice.

FIG. 10 is another schematic view of the second embodiment of the present disclosure in practice.

FIG. 11 is a schematic view of the first embodiment of the present disclosure in practice.

### DETAILED DESCRIPTION OF THE EXEMPLARY EMBODIMENTS

The present disclosure is more particularly described in the drawings and following examples that are intended as illustrative only since numerous modifications and variations therein will be apparent to those skilled in the art.

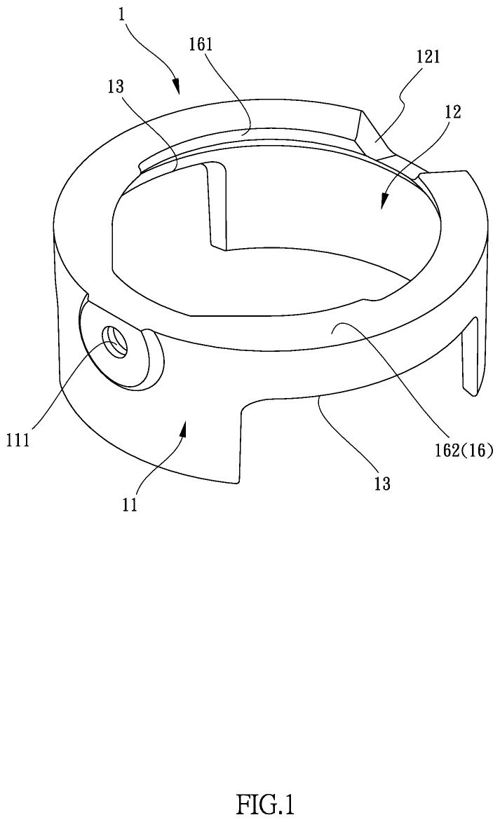

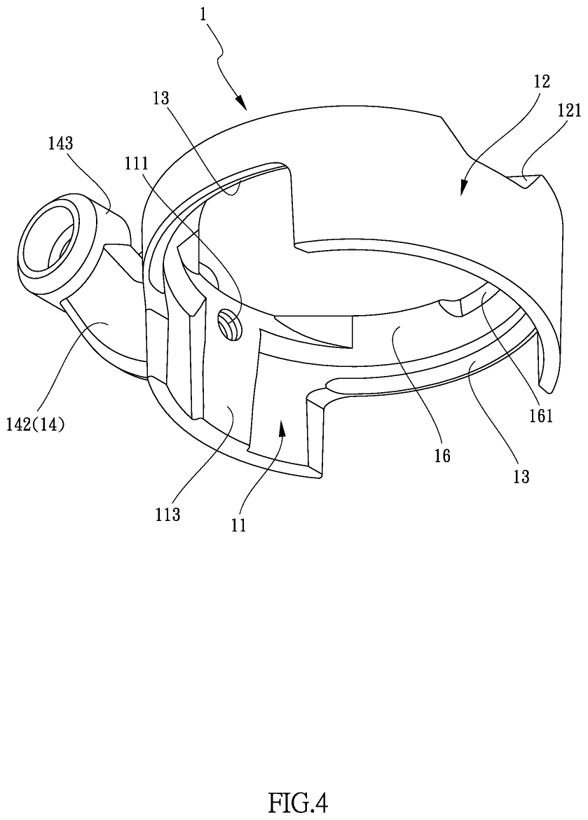

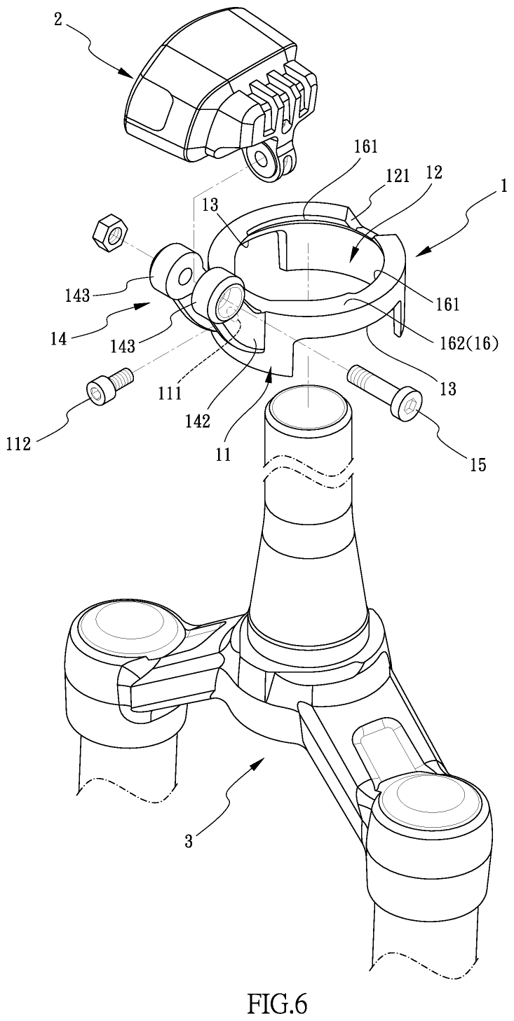

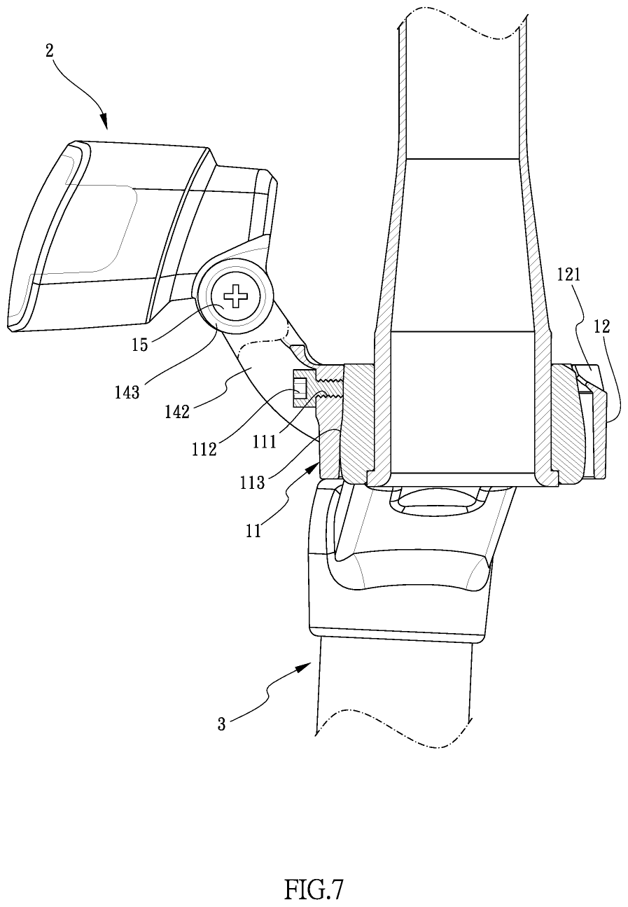

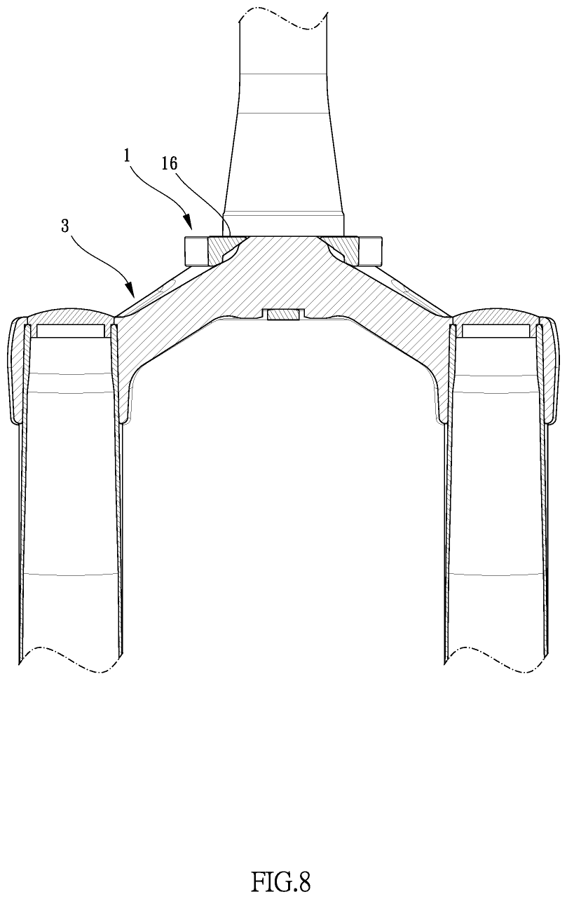

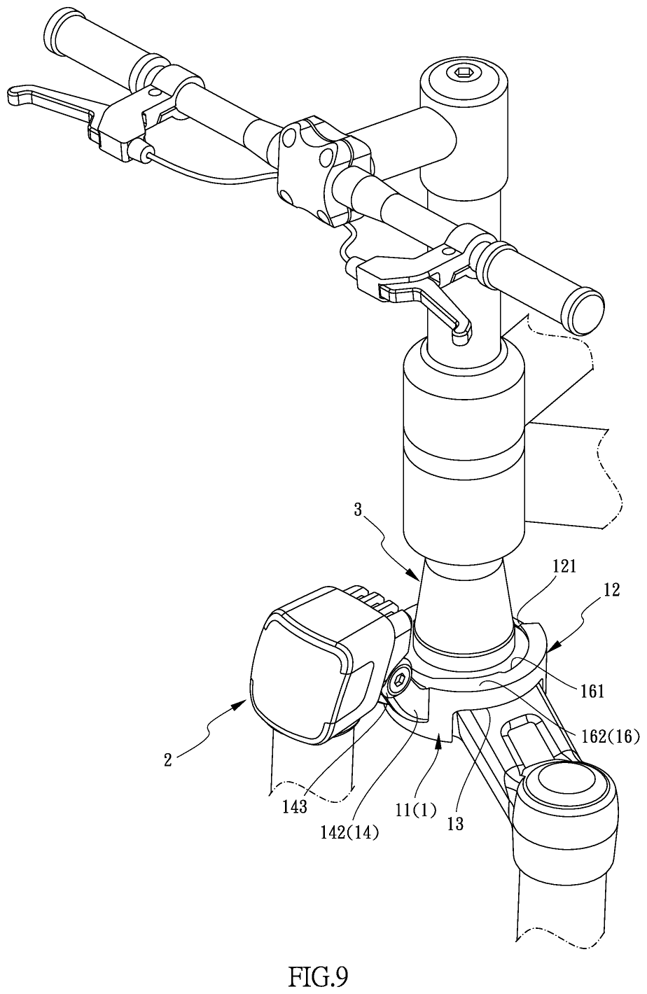

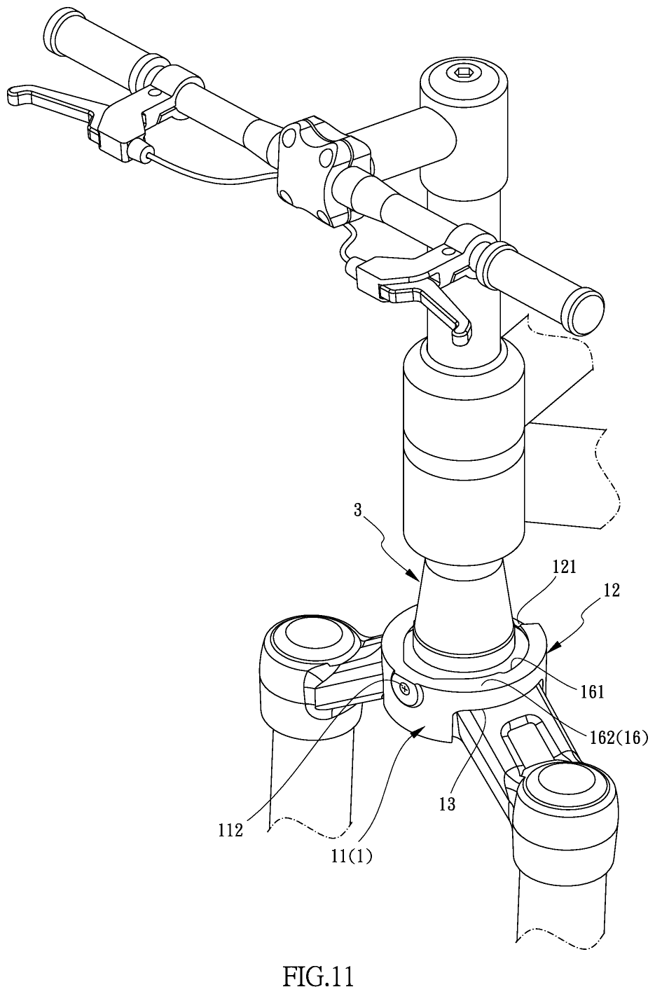

Referring to FIGS. 1 to 11, the first embodiment of the present disclosure provides a bicycle front fork crown structure, including an annular base 1, the annular base 1 includes a front cover 11, a rear cover 12, and an engaging groove 13 between the front cover 11 and the rear cover 12. The engaging groove 13 is formed by recessing the lower end of the annular base 1 to the upper end. The front cover 11 has a fixing hole 111.

Further, as shown in FIGS. 1-11, the annular base of the present disclosure includes fixing fastener 112 threadedly engaged to the fixing hole 111. According to the type of the bicycle front fork 3, the fixing fastener 112 can be in different fasteners, so that the annular base 1 abuts against the bicycle front fork 3 or threadedly engages to the bicycle front fork 3 (as shown in the FIGS, the annular base 1 abuts against the bicycle front fork 3).

In practice, as shown in FIGS. 1-11, the user only needs to detach the handlebar of the bicycle from the front fork 3 of the bicycle, and then place the structure from the top of the top tube of the front fork 3 of the bicycle in the direction that the front cover 11 of the structure direct towards the front of the bicycle, so that the structure of the present disclosure is sleeved around the top tube of the front fork 3 of the bicycle movably. The bifurcation of the front fork 3 of the bicycle blocks the structure and a fixing fastener 112 threadedly engages with the fixing hole 111, so as to fix the structure at the front fork 3 of the bicycle.

As shown in FIGS. 1-11, when the annular base 1 is disposed on the front fork 3, the annular base 1 is sleeved around the bifurcation between the top tube of the bicycle front fork 3 and the bicycle front fork 3, the fixing hole 13 is partially attached (fastened) on the two forks of the bicycle front fork 3, and the fixing hole 111 connects the forks of the bicycle front fork 3 and the outer side of the annular base 1.

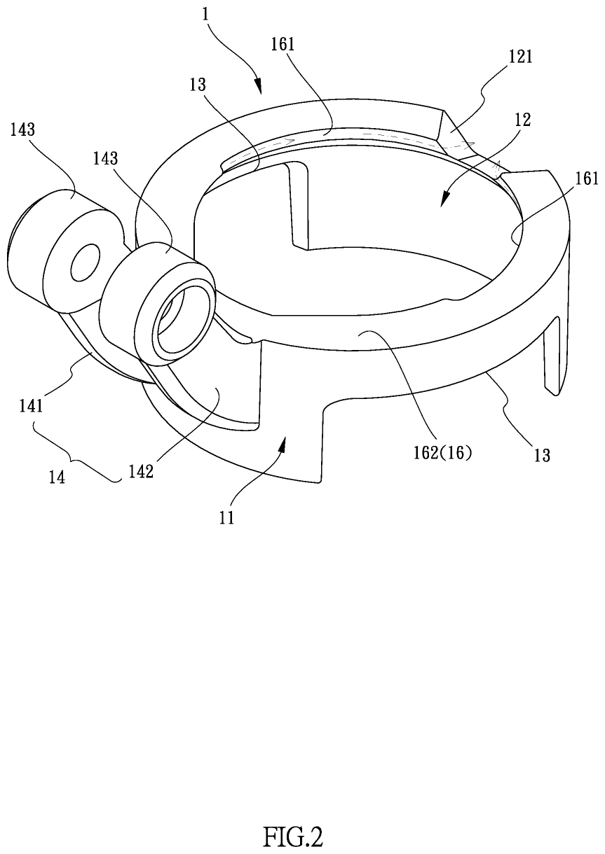

In addition, as shown in FIGS. 2-10, the present disclosure has a second embodiment, the front cover 11 has an extension portion 14 extended outward from the front cover 11. The extension portion 14 includes a first assembly rib 141 and a second assembly rib 142 spaced apart.

Further, as shown in FIGS. 2-11, the structure of the second embodiment of the present disclosure includes a light 2, and one end of the first assembly rib 141 and one end of the second assembly rib 142 have assembly portions 143, the light 2 is fixedly or pivotably disposed on the assembly portion 143. The light 2 is used for lighting to provide the safety of the user riding a bicycle at night, and at the same time, the assembly portion 143 serves as a stable base to support the light 2.

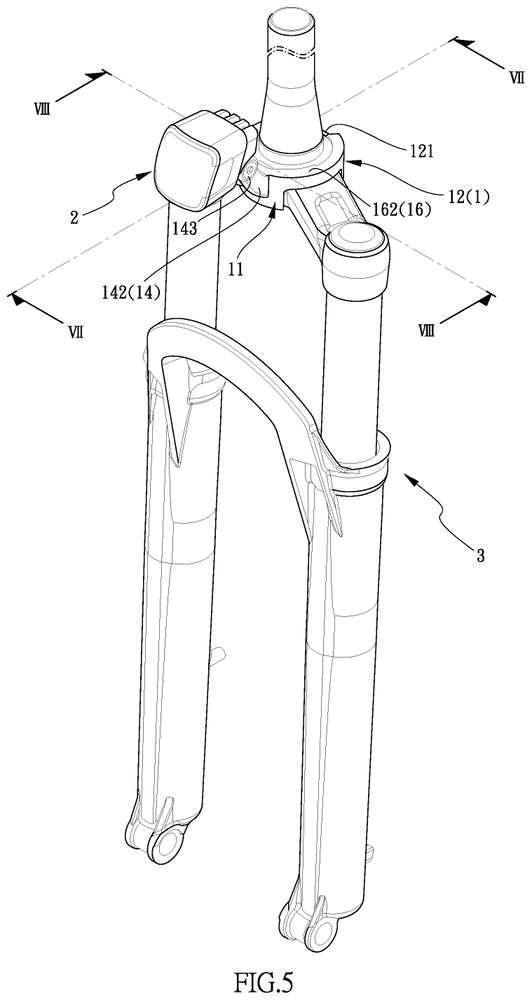

Furthermore, as shown in FIGS. 5-10, the annular base 1 includes a screw 15, and the light 2 is threadedly engaged on the assembly portion 143 by the screw 15.

Moreover, as shown in FIGS. 1-11, the inner side of the annular base 1 includes an inner convex ring 16 extended inward, and the inner convex ring 16 is attached to a bifurcation of the top tube of the bicycle front fork 3 and the bicycle front fork 3, so that the stability of the structure of the present disclosure mounting on the bicycle front fork 3 can be increased.

Referring to FIGS. 1-11, the inner convex ring 16 of the present disclosure has an inner convex ring surface 162, which mainly adorns the coordination of the appearance of the front forks of various bicycles and the balance with the overall aesthetic feeling.

Moreover, the inner convex ring 16 is attached to a bifurcation of the top tube of the bicycle front fork 3 and the bicycle front fork 3. The inner convex ring 16 can be designed to be wider or narrower according to the bicycle type frames, so as to adapt to different types of bicycle front forks 3, as well as to increase the stability and aesthetics, and to prevent the structure of the present disclosure from shaking.

Further, as shown in FIGS. 1-11, the inner convex ring 16 covers the bifurcation of the top tube of the bicycle front fork 3 and the bicycle front fork 3, so that the intersection of the bifurcation of the bicycle front fork 3 can be hidden. Therefore, the overall aesthetics and coordination of the bike can be improved.

In addition, the inner convex ring 16 has a water guide ring groove 161 partially recessed in the inner convex ring 16, and the rear cover 12 includes a drainage channel 121, and the water guide ring groove 161 is communicated with the drainage channel 121. The water guide ring groove 161 is used to guide the water stagnated in the inner convex ring 16 to the drainage groove 121 to flow out of the annular base 1, so as to prevent rainwater and dirty water from staying in the annular base 1 and causing damage to the annular base 1.

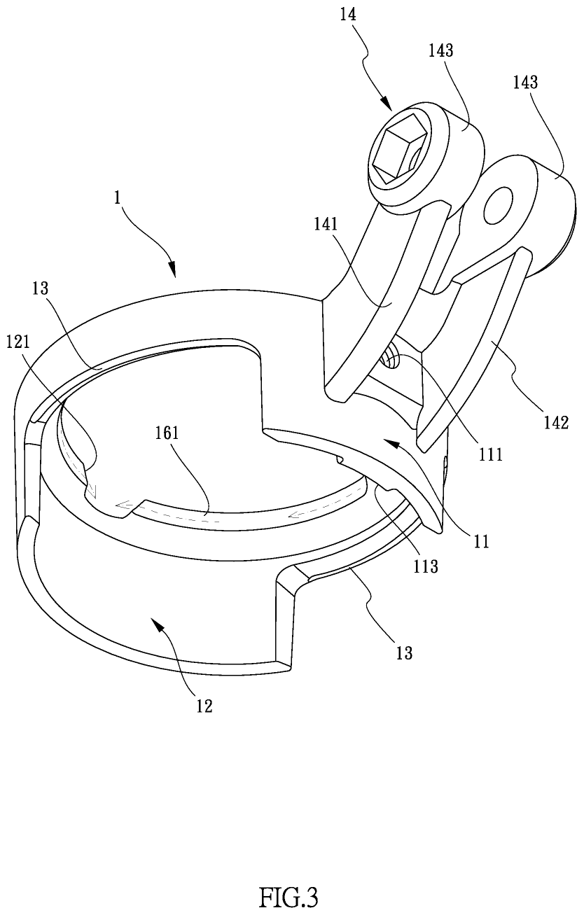

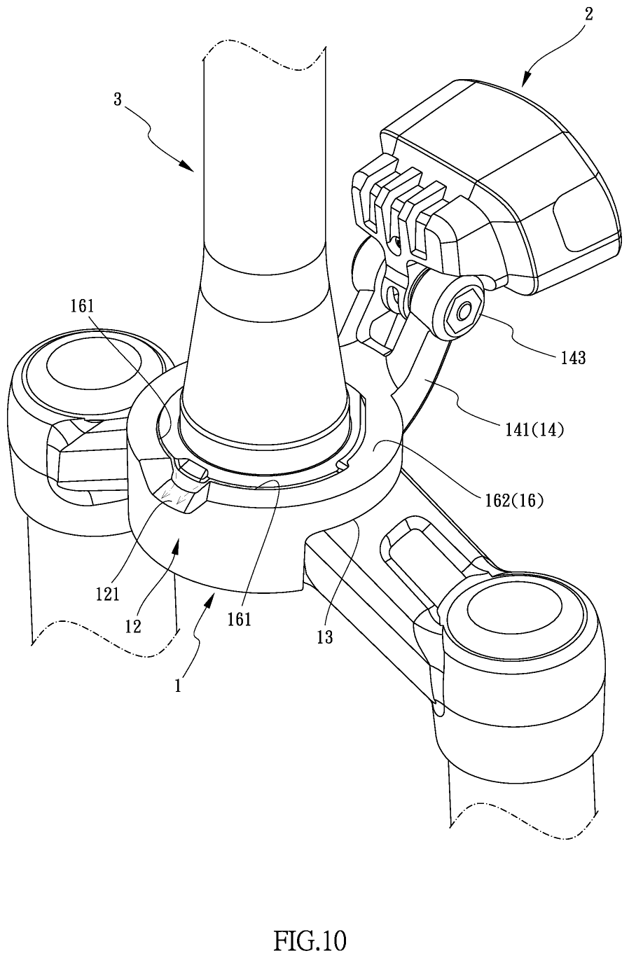

Referring to FIG. 2, FIG. 3, and FIG. 10, the dotted arrows refer to the direction of drainage in the water guide ring groove 161 of the present disclosure in practice with water.

Moreover, as shown in FIGS. 1-11, the front cover 11 includes a fixing protrusion 113 extended inwardly to the annular base 1. The fixing protrusion 113 is used to auxiliary engage with the bifurcation between the top tube of the bicycle front fork 3 and the bicycle front fork 3, so that the stability of the structure of the present disclosure mounting on the bicycle front fork 3 can be increased. The light 2 can be fixed to prevent bouncing and shaking when riding.

Finally, the bicycle front fork crown structure of the present disclosure is not limited to any material. The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

What is claimed is:

1. A bicycle front fork crown structure, comprising:
an annular base, including a front cover, a rear cover, and an engaging groove between the front cover and the rear cover; wherein the front cover has a fixing hole.

2. The bicycle front fork crown structure according to claim 1, wherein the front cover has an extension portion extended outward from the front cover; wherein the extension portion includes a first assembly rib and a second assembly rib spaced apart.

3. The bicycle front fork crown structure according to claim 2, wherein one end of the first assembly rib and one end of the second assembly rib have assembly portions.

4. The bicycle front fork crown structure according to claim 3, including a light disposed on the assembly portion.

5. The bicycle front fork crown structure according to claim 4, wherein the annular base includes at least one screw, the light is threadedly engaged on the assembly portion by the screw.

6. The bicycle front fork crown structure according to claim 1, including a fixing fastener threadedly engaged to the fixing hole.

7. The bicycle front fork crown structure according to claim 1, wherein the inner side of the annular base includes an inner convex ring extended inward.

8. The bicycle front fork crown structure according to claim 7, wherein the inner convex ring is attached to a bifurcation of the top tube of the bicycle front fork and the bicycle front fork.

9. The bicycle front fork crown structure according to claim 7, wherein the inner convex ring covers a bifurcation of the top tube of the bicycle front fork and the bicycle front fork.

10. The bicycle front fork crown structure according to claim 7, wherein a water guide ring groove is partially recessed in the inner convex ring, and the rear cover includes a drainage channel, and the water guide ring groove is communicated with the drainage channel.

11. The bicycle front fork crown structure according to claim 1, wherein the front cover includes a fixing protrusion extended inwardly to the annular base.
